(19) United States
(12) Patent Application Publication
(10) Pub. No.: US 2022/0248890 A1
(43) Pub. Date: Aug. 11, 2022

(54) METHOD FOR STOPPING MOTOR OPERATION OF ELECTRIC WINDOW CURTAIN

(71) Applicant: WEN YING LIANG, Changhua County (TW)

(72) Inventor: WEN YING LIANG, Changhua County (TW)

(21) Appl. No.: 17/220,561

(22) Filed: Apr. 1, 2021

(30) Foreign Application Priority Data
Feb. 9, 2021 (TW) 110104921

(51) Int. Cl. A47H 5/02; H02K 11/27

(52) U.S. Cl. CPC A47H 5/02; A47H 2005/025; H02K 11/27

(57) ABSTRACT

A method for stopping motor operation of an electric window curtain which includes a motor, a scrolling unit being driven by the motor, and a controlling member that controls operation of the motor to activate the scrolling unit to operate ropes to move a curtain. The method includes a detector connected to the motor to detect a load current of the motor. When the curtain moves downward and is interfered to stop, the load current for the motor reduces to close to a non-load current, the detector detects the non-load current of the motor, and the controlling member demands the motor to stop to prevent the ropes from being tied.

### BACKGROUND OF THE INVENTION

### 1. Fields of the Invention

The present invention relates to a method for stopping motor operation when the curtain is interfered during movement of an electric window curtain.

### 2. Descriptions of Related Art

The conventional electric window curtain includes a motor and a controlling member. The controlling member is used to control the shaft of the motor to be operated clockwise or counter clockwise to move the curtain upward or downward.

However, when window curtain is interfered by an object that is located on the path of the movement of the curtain, for example, the curtain is lowered, the motor does not stop automatically. Therefore, the scrolling unit continues to release the ropes which will wrapped to the scrolling unit irregularly. When the curtain is operated to be lifted, the motor pulls the ropes which may be stocked on the scrolling unit, the curtain becomes tilt or even worse, the curtain cannot be operated due to the ropes are tied.

The present invention intends to provide a method for stopping motor operation when the curtain is interfered during movement of an electric window curtain such that the ropes are not tied.

### SUMMARY OF THE INVENTION

The present invention relates to a method for stopping motor operation of an electric window curtain. The electric window curtain includes a motor, a scrolling unit being driven by the motor, and a controlling member controlling operation of the motor to activate the scrolling unit to operate ropes to move a curtain. The method comprises a detector connected to the motor to detect the load current of the motor. When the curtain moves downward and is interfered to stop, the load current for the motor reduces to close to a non-load current, the detector detects the non-load current of the motor, and the controlling member demands the motor to stop.

When the object to cause the stop of the curtain is removed, the motor starts to work by the work current to lower the curtain.

The advantages of the present invention are that the controlling member of the present invention is able to set the desired distance that the curtain moves. The present invention is suitable for any window curtain in the market.

The motor and the detector are located in the top rail or the bottom rail of the electric window curtain, such that the electric window curtain is neat and meets aesthetic requirements.

The present invention does not need any induction element or detection part exposed from the window. The method of the present invention can be set easily and not extra programs needed.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the elements of the method used to an electric window curtain of the present invention;

FIG. 2 shows the block diagram of the method of the present invention;

FIG. 3 shows that an object interferes the downward movement of the curtain, and

FIG. 4 shows the processes that the method judges the curtain is interfered to be stopped.

### DETAILED DESCRIPTION OF THE PREFERRED EMBODIMENT

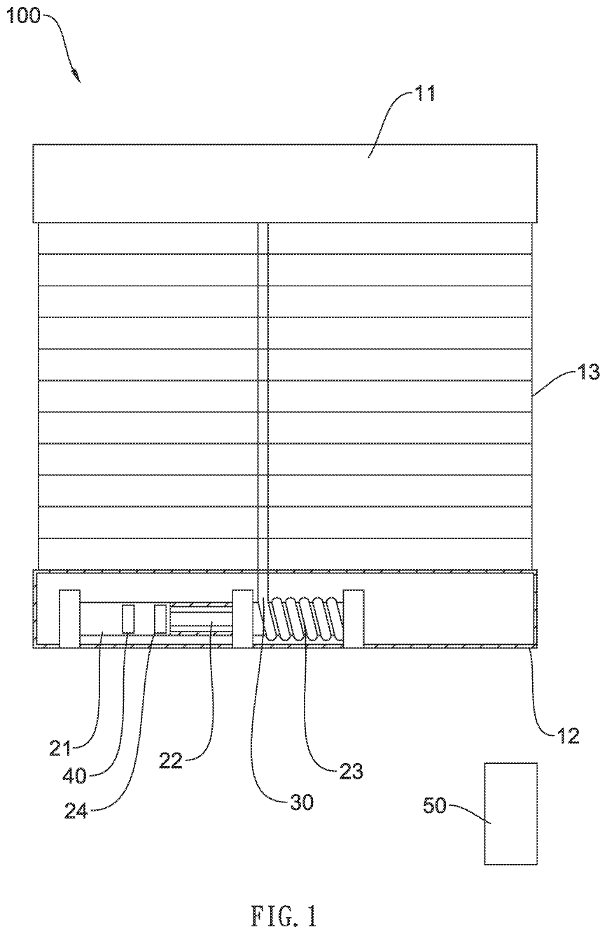

Referring to FIGS. 1 to 4, an electric window curtain 100 includes a motor 21, a scrolling unit 23 being driven by the motor 21, and a controlling member 40 controlling operation of the motor 21 to activate the scrolling unit 23 to operate ropes 30 to move a curtain 13.

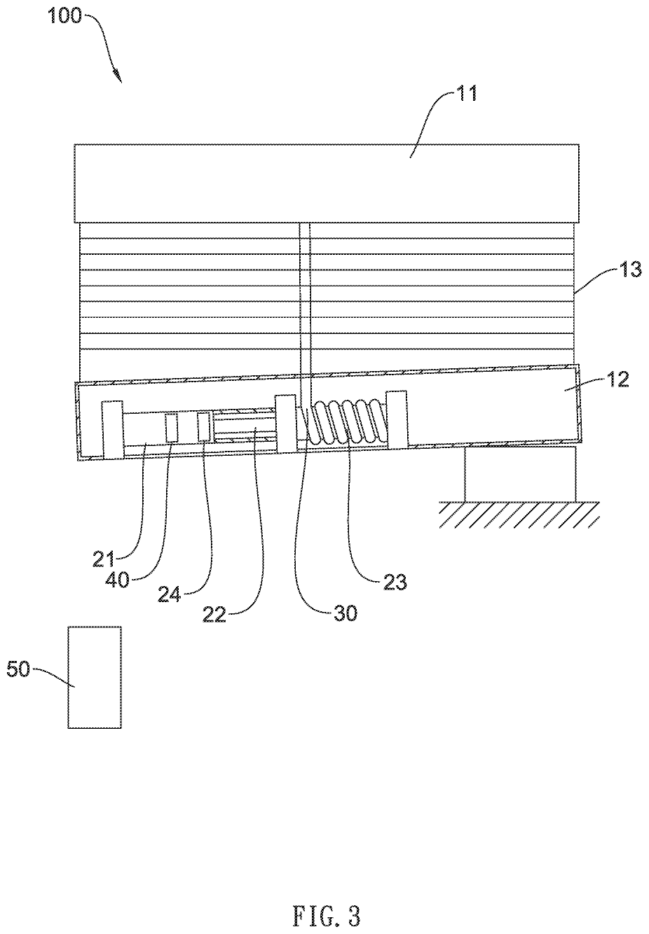

Specifically, the electric window curtain 100 includes a top rail 11, a bottom rail 12 and the curtain 13 that is connected between the top rail 11 and the bottom rail 12. The motor 21 is located in the bottom rail 12 and includes a shaft 22 which drives the scrolling unit 23, and the scrolling unit 23 controls operation of the ropes 30 to move the curtain 13 up and down. It is noted that the motor 21 and the scrolling unit 23 can also be located in the top rail 11 as shown in FIGS. 1 and 3.

The controlling member 40 is a wired controlling member 40 or a wireless controlling member 40. Alternatively, the controlling member 40 is a micro controlling unit (MCU) which includes a control chip and a remote controller 50 such that the controlling member 40 can be controlled remotely. The detector 24 is a microchip which can be installed in the motor 21 to save weight and room.

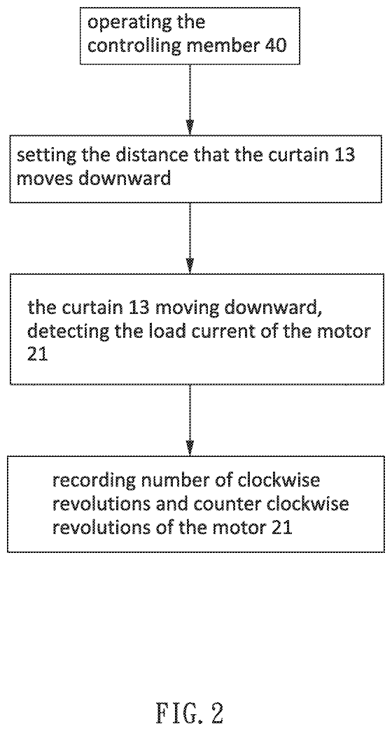

As shown in FIG. 2, the controlling member 40 controls the distance that the curtain 13 moves downward, such as the distance is set to be 80 cm, 100 cm or 150 cm. The motor 21 is activated and the shaft 22 rotates to demand the scrolling unit 23 to release the ropes 30 to lower the curtain 13. The controlling member 40 records the number of clockwise revolutions and counter clockwise revolutions of the motor 21. The detector 24 connected to the motor 21 detects the load current of the motor 21.

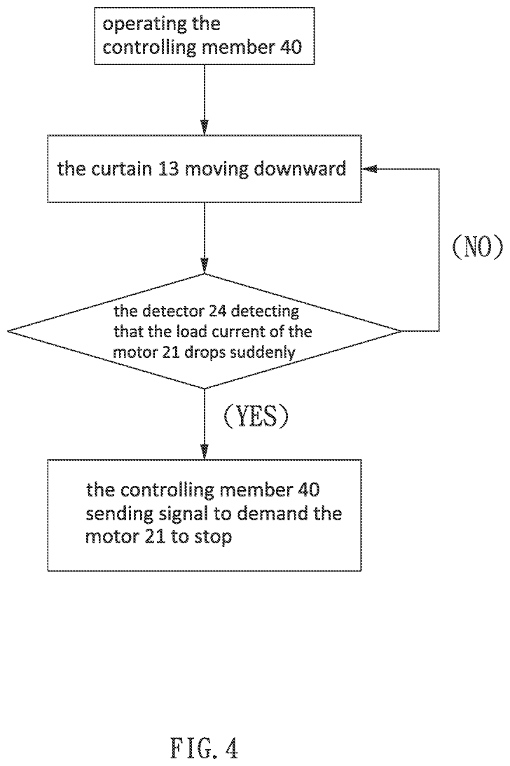

As shown in FIGS. 3 and 4, when the curtain 13 is interfered to stop, the load current for the motor 21 reduces and the load current is close to the non-load current, about 200 mA, the detector 24 detects the non-load current of the motor 21, and the controlling member 40 judges that the curtain 13 is interfered, so that the controlling member 40 demands the motor 21 to stop to prevent the ropes 30 from being tied.

After the object to cause the stop of the curtain 13 is removed, the load current of the motor 21 is detected, then the controlling member 40 demands the motor 21 to work to lower the curtain 13 to the set distance.

The controlling member 40 of the present invention can set the desired distance that the curtain 13 moves, and can be used to any window curtain in the market.

The motor 21 and the detector 24 are located in the top rail 11 or the bottom rail 12 of the electric window curtain 100, so that the electric window curtain 100 is neat and meets aesthetic requirements.

The present invention does not need any induction element or detection part exposed from the electric window curtain 100. The method of the present invention can be set easily and not extra programs needed.

While we have shown and described the embodiment in accordance with the present invention, it should be clear to those skilled in the art that further embodiments may be made without departing from the scope of the present invention.

What is claimed is:

1. A method for stopping motor operation of an electric window curtain which includes a motor, a scrolling unit being driven by the motor, and a controlling member controlling operation of the motor to activate the scrolling unit to operate ropes to move a curtain, the method comprising:
a detector connected to the motor to detect a load current of the motor, when the curtain moves downward and is interfered to stop, the load current for the motor reduces to close to a non-load current, the detector detects the non-load current of the motor, and the controlling member demands the motor to stop.

2. The method as claimed in claim 1, wherein the electric window curtain includes a top rail, a bottom rail and the curtain connected between the top rail and the bottom rail, the motor is located in the bottom rail and includes a shaft, the scrolling unit controls operation of the ropes to move the curtain up and down.

3. The method as claimed in claim 1, wherein the motor and the scrolling unit are located in the top rail.

4. The method as claimed in claim 1, wherein the controlling member is a wired controlling member or a wireless controlling member.

5. The method as claimed in claim 1, wherein the controlling member is a micro controlling unit which includes a control chip and a remote controller so as to control the controlling member remotely.

6. The method as claimed in claim 1, wherein the detector is a microchip.

7. The method as claimed in claim 5, wherein the controlling member records a number of clockwise revolutions and counter clockwise revolutions of the motor.
